(19) United States
(12) Patent Application Publication
(10) Pub. No.: US 2012/0188099 A1
(43) Pub. Date: Jul. 26, 2012

(54) TRAFFIC SIGNAL PREEMPTION SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/109,049

(22) Filed: May 17, 2011

(30) Foreign Application Priority Data
Jan. 26, 2011 (TW) 100102920

(51) Int. Cl. G08G 1/08

(52) U.S. Cl. 340/906

(57) ABSTRACT

A traffic signal preemption system includes a positioning unit, a storage unit, a processing unit, and a control unit. The positioning unit detects a location, a direction, and speed of a vehicle, and outputs a location signal correspondingly. The storage unit stores geographic information. The processing unit gets the geographic information corresponding to the location of the vehicle from the storage unit, thereby estimating a traffic signal location, which the vehicle approaches and a corresponding approach time according to the direction and the speed of the vehicle, respectively. The control unit manipulates the traffic signal according to the approach time of the vehicle through a traffic control system.

### BACKGROUND

1. Technical Field

The present disclosure relates to a traffic system and method, and particularly to a traffic signal preemption system and method.

2. Description of Related Art

During an emergency, an emergency vehicle such as police cars, fire trucks, and ambulances often have to move quickly even on a crowed road, and might even have to run red lights while utilizing sirens or flashing lights to warn other drivers and pedestrians on the road. However, it is usually difficult for the drivers of other vehicles and pedestrians to determine the location of the emergency vehicle and react to the warnings immediately. As a result, traffic accidents often occur.

Traffic signal preemption is a type of system that allows the normal operation of traffic lights to be preempted. The most common use of these systems is to manipulate traffic signals in the path of an emergency vehicle, stopping conflicting traffic and allowing the emergency vehicle right-of-way, to help reduce response times and enhance traffic safety. Because traffic lights can be controlled by specific traffic preemption devices, unmatched traffic preemption devices or lights or vehicles without a traffic preemption device does not benefit from the traffic signal preemption.

What is needed, accordingly, is a traffic system capable of overcoming the limitation described.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of a first embodiment of a traffic signal preemption system of the present disclosure.

FIG. 2 is a schematic view of the operation of the traffic signal preemption system of FIG. 1.

FIG. 3 is a block diagram of a second embodiment of a traffic signal preemption system of the present disclosure.

FIG. 4 is a flowchart of a first embodiment of a traffic signal preemption method of the present disclosure.

FIG. 5 is a flowchart of a second embodiment of a traffic signal preemption method of the present disclosure.

### DETAILED DESCRIPTION

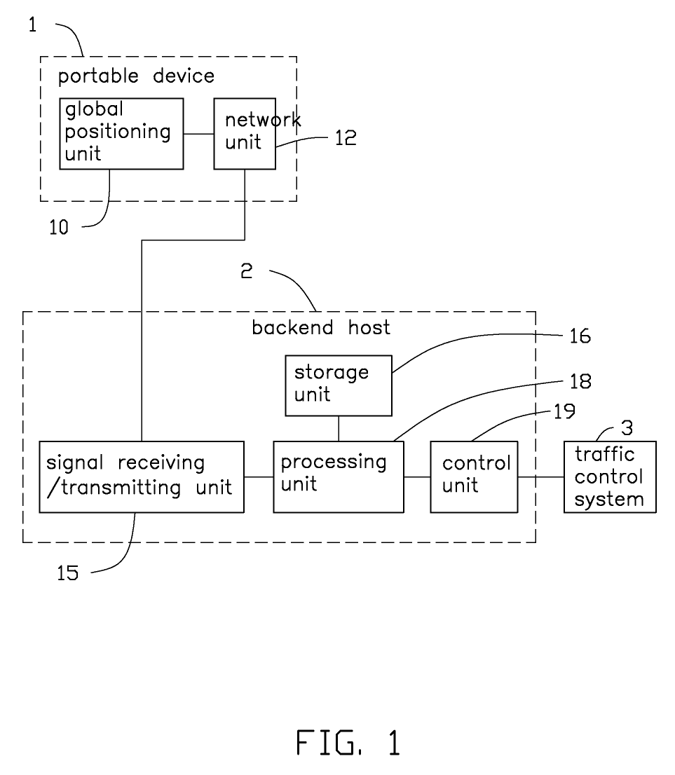

FIG. 1 is a first embodiment of a traffic signal preemption system of the present disclosure. In this embodiment, the traffic signal preemption system is used in a vehicle such as a police car, a fire truck, or an ambulance. As shown in FIG. 1, the traffic signal preemption system includes a global positioning unit 10, a network unit 12, a signal receiving/transmitting unit 15, a storage unit 16, a processing unit 18, and a control unit 19. The global positioning unit 10 and the network unit 12 are embedded in a portable device 1 such as a mobile phone, and the signal receiving/transmitting unit 15, the storage unit 16, the processing unit 18, and the control unit 19 are embedded in a backend host 2. The backend host 2 is capable of communicating with a traffic control system 3, thereby manipulating the traffic signals of a city.

The portable device 1 is in the vehicle. The global positioning unit 10 detects the tactical information of the vehicle including a location, a direction, or speed, and outputs a corresponding location signal to the backend host 2 through the network unit 12.

The signal receiving/transmitting unit 15 receives the location signal from the portable device, and transmits the location signal to the processing unit 18. The storage unit 16 stores geographic information of the city and environs that the emergency vehicle is operating in. The processing unit 18 retrieves the geographic information corresponding to the location of the vehicle such as the geographic information of one kilometer around the vehicle from the storage unit 16 according to the location signal. In this embodiment, the processing unit 18 further utilizes the geographic information to estimate locations of traffic signals, which the vehicle approaches and a time the vehicle will arrive at the traffic signals, according to the direction and the speed of the vehicle, respectively. However, in other embodiments, the processing unit 18 can utilize the geographic information to estimate locations of traffic signals on the route to a destination and a time the vehicle will approach at the traffic signals, according to the direction and the speed of the vehicle, respectively. The control unit 19 manipulates the traffic signals according to the approach time of the vehicle through the traffic control system, to grant the right-of-way in the desired direction. Consequently, the driver or the passenger of the vehicle is capable of making certain the traffic signals have properly changed before the vehicle approaches to help enhance traffic safety and reduce response times through use of the portable device 1.

Operation of the disclosed traffic signal preemption system is described through the following illustrative example.

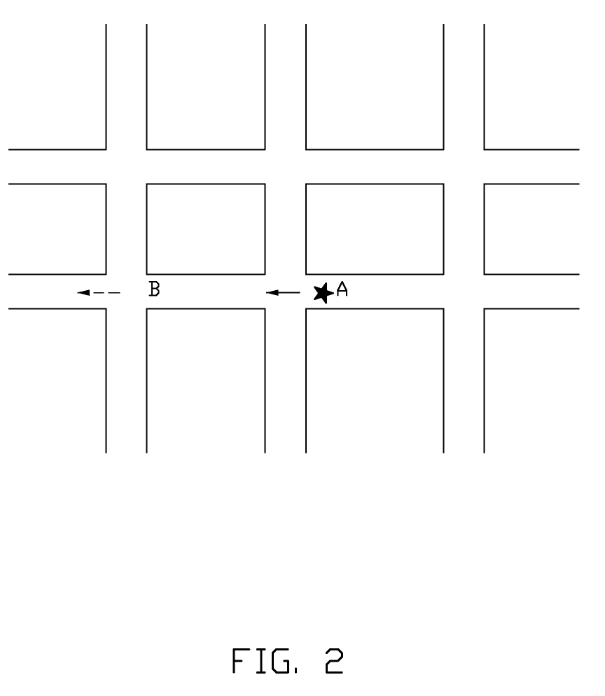

As shown in FIG. 2, an emergency vehicle is moving from a point A to a point B. The location (point A), the direction (from the right to the left), and the speed (X km/h) of the emergency vehicle are detected by the global positioning unit 10. After receiving a location signal from the global positioning unit 10, the processing unit 18 gets the geographic information corresponding to the location of the vehicle from the storage unit 16. The processing unit 18 further utilizes the geographic information to estimate a time the vehicle will approach a traffic signal at point B according to the direction and speed of the vehicle. The control unit 19 manipulates the traffic signal of point B prior to the vehicle approaching the traffic signal of point B. So the traffic signal of point B gives the vehicle the right-of-way, that is, the green light, before the vehicle approaches. For example, changing the light to green before the vehicle arrives at the intersection near to point B. When the vehicle is at point B, the processing unit 18 receives another location signal and estimates the location of the next traffic signal, which the vehicle approaches, and the control unit 19 correspondingly manipulates the next traffic signal. Consequently, traffic safety is enhanced and response times are reduced through use of the portable device 1.

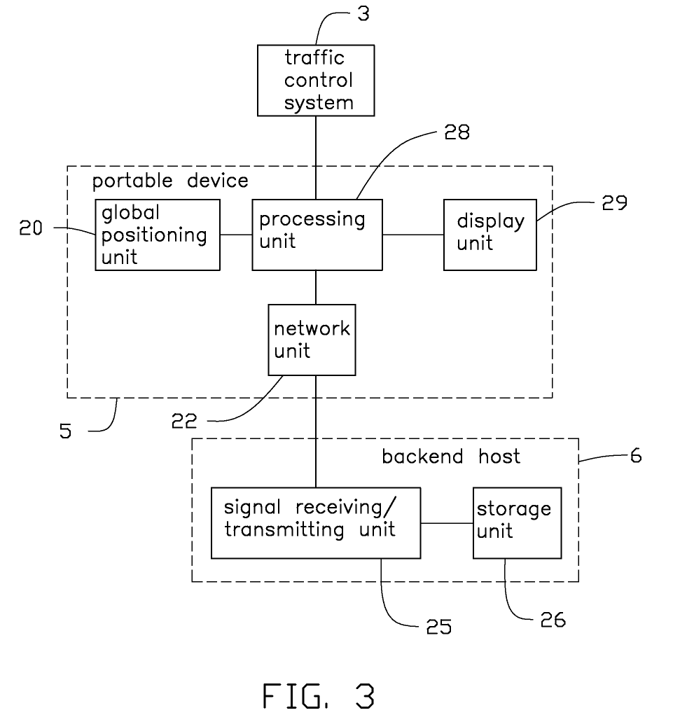

FIG. 3 is a second embodiment of a traffic signal preemption system of the present disclosure. As shown in FIG. 3, the traffic signal preemption system includes a global positioning unit 20, a network unit 22, a signal receiving/transmitting unit 25, a storage unit 26, a processing unit 28, and a display unit 29. The global positioning unit 20, the network unit 22, the processing unit 28, and the display unit 29 are embedded in a portable device 5, and the signal receiving/transmitting unit 25 and the storage unit 26 are embedded in a backend host 6.

The storage unit 26 stores geographic information of the city and environs that the emergency vehicle is operating in.

In this embodiment, the portable device 5 is in the vehicle. The global positioning unit 20 detects the location of the vehicle, and transmits the location to the processing unit 28. The processing unit 28 retrieves the geographic information corresponding to the location of the vehicle such as the geographic information of one kilometer around the vehicle from the storage unit 26 according to the location signal through the network unit 22 and the signal receiving/transmitting unit 25, thereby displaying the geographic information on the display unit 29.

In this embodiment, since the portable device 5 is in the vehicle, the driver or the passenger of the vehicle can manipulate the traffic signals along the route to the destination by transmitting a corresponding control signal to the processing unit 28. The processing unit 28 transmits the control signal to the traffic control system 3 through the network unit 22, thereby granting the right-of-way in the desired direction through turning the corresponding traffic signals before the vehicle approaches. As a result, traffic safety is enhanced and response times are reduced through use of the portable device 1.

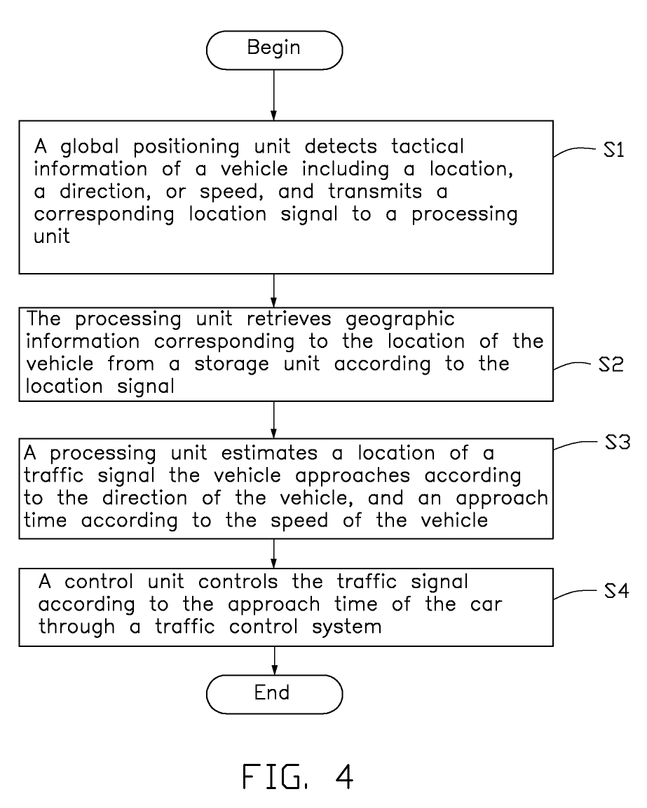

As shown in FIG. 4, a first embodiment of a traffic signal preemption method of the present disclosure is as follows. Depending on the embodiment, additional steps may be added, others removed, and the ordering of the steps may be changed.

In step S1, the global positioning unit 10 detects the tactical information of a vehicle including a location, a direction, or speed, and outputs a corresponding location signal to the processing unit 18. In this embodiment, the location signal is outputted through the network unit 12 and the signal receiving/transmitting unit 15.

In step S2, the processing unit 18 retrieves geographic information corresponding to the location of the vehicle such as the geographic information of one kilometer around the vehicle from the storage unit 16 according to the location signal.

In step S3, the processing unit 18 estimates a location of a traffic signal the vehicle approaches according to the direction of the vehicle, and an approach time according to the speed of the vehicle.

In step S4, the control unit 19 manipulates the traffic signal according to the approach time of the vehicle through the traffic control system 3, to grant the right-of-way in the desired direction. As a result, the driver or the passenger of the vehicle is capable of making certain the traffic signals have properly changed before the vehicle approaches to help enhance traffic safety and reduce response times through use of the portable device 1.

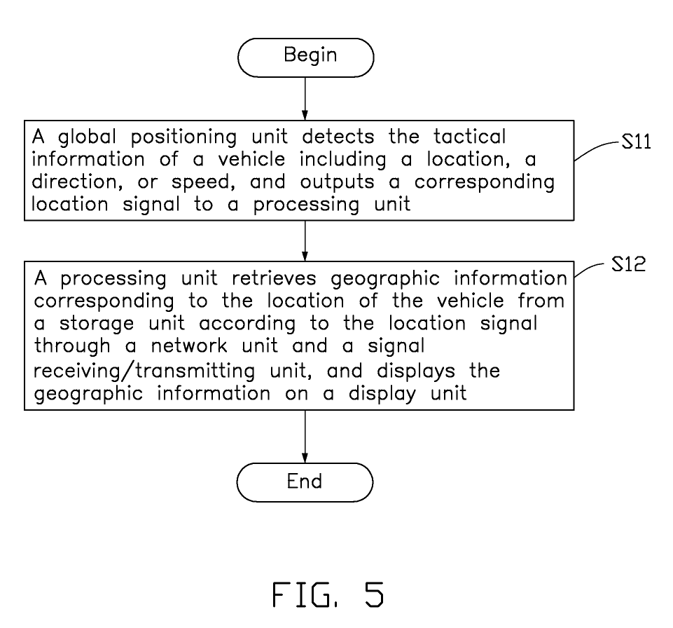

As shown in FIG. 5, a second embodiment of a traffic signal preemption method of the present disclosure is as follows. Depending on the embodiment, additional steps may be added, others removed, and the ordering of the steps may be changed.

In step S11, the global positioning unit 20 detects the tactical information of a vehicle including a location, a direction, or speed, and outputs a corresponding location signal to the processing unit 28.

In step S12, the processing unit 28 retrieves geographic information corresponding to the location of the vehicle such as the geographic information of one kilometer around the vehicle from the storage unit 26 according to the location signal through the network unit 22 and the signal receiving/transmitting unit 25, and displays the geographic information on the display unit 29.

Consequently, the driver or the passenger of the vehicle can manipulate the traffic signals along the route to the destination by transmitting a corresponding control signal to the traffic control system 3 through the network unit 22, thereby granting the right-of-way in the desired direction through turning the corresponding traffic signals before the vehicle approaches. As a result, traffic safety is enhanced and response times are reduced through use of the portable device 1.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A traffic signal preemption system, comprising:
a positioning unit detecting a location, a direction, and speed of a vehicle, and outputting a location signal correspondingly;
a storage unit storing geographic information;
a processing unit getting the geographic information corresponding to the location of the vehicle from the storage unit according to the location signal, thereby estimating a location of a traffic signal the vehicle approaches and a corresponding approach time according to the direction and the speed of the vehicle, respectively; and
a control unit manipulating the traffic signal according to the approach time of the vehicle through a traffic control system.

2. The traffic signal preemption system of claim 1, wherein the positioning unit is embedded in a portable device including a network unit, and the storage unit, the processing unit and the control unit are embedded in a host including a signal receiving/transmitting unit, the positioning unit communicates with the processing unit through the network unit and the signal receiving/transmitting unit.

3. The traffic signal preemption system of claim 1, wherein the processing unit retrieves the geographic information of one kilometer around the vehicle from the storage unit according to the location signal.

4. The traffic signal preemption system of claim 1, wherein the processing unit utilizes the geographic information to estimate at least a traffic signal location on the route to a destination according to the direction of the vehicle.

5. A traffic signal preemption method comprising the following steps:
utilizing a positioning unit to detect a location, a direction, and speed of a vehicle, and output a corresponding location signal;
getting geographic information corresponding to the location of the vehicle according to the location signal, thereby estimating a traffic signal location the vehicle approaches and a corresponding approach time according to the direction and the speed of the vehicle, respectively; and
manipulating the traffic signal according to the approach time of the vehicle through a traffic control system.

6. The traffic signal preemption method of claim 5, wherein the geographic information of one kilometer around the vehicle is retrieved.

7. The traffic signal preemption method of claim 5, wherein the step of “getting geographic information” includes “getting geographic information corresponding to the location of the vehicle according to the location signal, thereby estimating at least a traffic signal location on the route to a destination and at least a corresponding approach time according to the direction and the speed of the vehicle, respectively”.

8. A traffic signal preemption system, comprising:
a positioning unit detecting a location of a vehicle;
a storage unit storing geographic information;
a processing unit getting the geographic information corresponding to the location of the vehicle from the storage unit according to the location signal; and
a display unit displaying the geographic information retrieved by the processing unit, wherein the processing unit further receives a control signal from a user, thereby manipulating at least a traffic signal selected by the user through a traffic control system.

9. The traffic signal preemption system of claim 8, wherein the positioning unit, the processing unit, and the display unit are embedded in a portable device including a network unit, the storage unit is embedded in a host including a signal receiving/transmitting unit, the processing unit communicates with the storage unit through the network unit and the signal receiving/transmitting unit.

10. The traffic signal preemption system of claim 8, wherein the processing unit retrieves the geographic information of one kilometer around the vehicle from the storage unit according to the location signal.
